(19) United States
(12) Patent Application Publication
(10) Pub. No.: US 2026/0274001 A1
(43) Pub. Date: Sep. 17, 2026

(54) SIDEWALL-REINFORCED BICYCLE RIM AND METHOD FOR MANUFACTURING THE SAME

(71) Applicant: Xiamen Carbonking Composites Technology Co., Ltd., Xiamen (CN)

(72) Inventor: Wurui LIU, Xiamen (CN)

(21) Appl. No.: 19/081,159

(22) Filed: Mar. 17, 2025

(30) Foreign Application Priority Data
Jan. 24, 2024 (CN) 202410102736.3

(51) Int. Cl. B60B 21/06; B29D 99/00; B29K 77/00; B29K 105/04; B29K 307/04

(52) U.S. Cl. CPC B60B 21/062; B29D 99/0032; B29K 2077/10; B29K 2105/04; B29K 2307/04; B60B 2360/33; B60B 2360/3416

(57) ABSTRACT

The present disclosure provides a sidewall-reinforced bicycle rim and a method for manufacturing the same. A sidewall-reinforced bicycle rim includes a rim body with a cavity, where a sidewall reinforcement member is separately embedded in each of inner walls on two sides, corresponding to the cavity, of the rim body, the sidewall reinforcement member includes a foaming body and reinforced carbon fiber layers that are attached to two sides of the foaming body, the foaming body is of a convex-ribbed mesh structure, a plurality of hollow holes are provided in the foaming body, and the reinforced carbon fiber layers on the two sides are closely attached at the hollow holes. Therefore, continuous delamination does not occur between the reinforced carbon fiber layer and the foaming body. This prevents delamination between the foaming body and the rim body, so that the reinforcing effect is better and reliability and stability are high.

### CROSS-REFERENCE TO RELATED APPLICATIONS

This application claims priority to Chinese Patent Application 202410102736.3, filed on Jan. 24, 2024, which is incorporated herein by reference.

### TECHNICAL FIELD

The present disclosure relates to the technical field of bicycle rims, and in particular, to a sidewall-reinforced bicycle rim and a method for manufacturing the same.

### BACKGROUND

At present, to achieve the purpose of lightweight, a bicycle rim is usually made of a carbon fiber material. In addition, to ensure the strength of the bicycle rim, foaming bodies are usually embedded in two sidewalls of the rim body, to enable the body to implement structural characteristics such as lightweight and high strength via the two foaming bodies. However, in this structure, the embedded foaming body isolates reinforced carbon fiber layers in the two sidewalls, and only the reinforced carbon fiber layers around the foaming body are combined with each other. As a result, the two reinforced carbon fiber layers of the embedded foaming body are not combined with each other. Due to this structural design, when the rim undergoes thermal expansion or external impacts, continuous delamination easily occurs between the reinforced carbon fiber layer and the foaming body, resulting in detachment of the reinforced material between the foaming body and the inner sidewall of the rim. Consequently, the reinforcing effect cannot be achieved and reliability and stability are poor. Because of the overall structure of the foaming body, the foaming body has a large size, is weight, and has insufficient rigidity. Therefore, there is a larger room for improvement.

### SUMMARY

The present disclosure is intended to provide a sidewall-reinforced bicycle rim, to resolve the above technical problems.

To achieve the above objective, the technical solution adopted by the present disclosure is: A sidewall-reinforced bicycle rim includes a rim body with a cavity, where a sidewall reinforcement member is separately embedded in each of inner walls on two sides, corresponding to the cavity, of the rim body, the sidewall reinforcement member includes a foaming body and a reinforced carbon fiber layer that is attached on each of two sides of the foaming body, the foaming body is a convex-ribbed mesh structure, a plurality of hollow holes are provided in the foaming body, and the reinforced carbon fiber layers on the two sides are closely attached at the hollow holes.

Preferably, the plurality of hollow holes are divided into an inner ring hollow hole group and an outer ring hollow hole group, the inner ring hollow hole group and the outer ring hollow hole group are concentrically disposed, and the hollow holes in the inner ring hollow hole group and the hollow holes in the outer ring hollow hole group are arranged in a staggered manner.

Preferably, the hollow hole is a regular hexagon.

Preferably, the sidewall reinforcement member is annular.

Preferably, the sidewall reinforcement member includes a plurality of arc-shaped sidewall reinforcement segments, and the plurality of sidewall reinforcement segments are sequentially spliced end to end, to form the annular sidewall reinforcement member.

Preferably, the foaming body is of a continuous convex-ribbed mesh structure.

Preferably, the foaming body is a PMI layer or a honeycomb sheet layer.

Preferably, density of the foaming body is in a range of 0.05 g/cm³ to 0.3 g/cm³.

Preferably, the rim body is a carbon fiber rim body.

The present disclosure further provides a method for manufacturing a sidewall-reinforced bicycle rim. The method includes:
S1, manufacturing an arc-shaped molding die, where two groups of regular hexagonal groove holes that are arranged in a staggered manner are provided on one side of a molding surface of the molding die;
S2, attaching and pressing a first reinforced carbon fiber layer within the molding surface first, then attaching and pressing the foaming body on the first reinforced carbon fiber layer, and then attaching and pressing a second reinforced carbon fiber layer on the foaming body;
S3, attaching the two reinforced carbon fiber layers to each other at a position corresponding to the regular hexagonal groove hole, to form a hexagonal concave surface, and forming a continuous regular hexagonal convex-ribbed mesh structure with the foaming body, thereby obtaining the arc-shaped sidewall reinforcement segment; and
S4, performing burring, smoothing, and cleaning on surfaces of the plurality of arc-shaped sidewall reinforcement segments, sequentially splicing, end to end, a plurality of arc-shaped sidewall reinforcement segments that are processed and cleaned, to form the annular sidewall reinforcement member, attaching the sidewall reinforcement member on inner walls on two sides of a pre-formed rim body through a reinforced carbon fiber layer, and finally putting the sidewall reinforcement member and the rim body into the molding die for molding, to obtain an intact reinforced rim.

The present disclosure has the following beneficial effects.

The sidewall-reinforced bicycle rim includes a rim body with a cavity, where a sidewall reinforcement member is separately embedded in each of inner walls on two sides, corresponding to the cavity, of the rim body, the sidewall reinforcement member includes a foaming body and reinforced carbon fiber layers that are attached to two sides of the foaming body, the foaming body is of a convex-ribbed mesh structure, a plurality of hollow holes are provided in the foaming body, and the reinforced carbon fiber layers on the two sides are closely attached at the hollow holes. When the rim undergoes thermal expansion or external impacts, continuous delamination does not occur between the reinforced carbon fiber layer and the foaming body. This prevents delamination between the foaming body and the rim body, so that the reinforcing effect is better and reliability and stability are high. Because of the convex-ribbed mesh structure of the foaming body, the foaming body has a small size, lightweight, and larger rigidity. Therefore, the rim is safer and more durable while the lightweight of the rim is ensured.

### BRIEF DESCRIPTION OF DRAWINGS

FIG. 1 is a three-dimensional view according to an embodiment of the present disclosure;

FIG. 2 is a sectional view (1) according to an embodiment of the present disclosure;

FIG. 3 is a sectional view (2) according to an embodiment of the present disclosure;

FIG. 4 is a longitudinal section view according to an embodiment of the present disclosure;

FIG. 5 is a schematic diagram of a structure of a foaming body according to an embodiment of the present disclosure;

FIG. 6 is a schematic diagram of fitting between a foaming body and a reinforced carbon fiber layer according to an embodiment of the present disclosure;

FIG. 7 is a sectional view at A-A in FIG. 2;

FIG. 8 is a sectional view at B-B in FIG. 2;

FIG. 9 is a sectional view at C-C in FIG. 2;

FIG. 10 is a sectional view at D-D in FIG. 2;

FIG. 11 is a sectional view at E-E in FIG. 2; and

FIG. 12 is a sectional view at F-F in FIG. 2.

Reference numerals: 1: rim body; 2: cavity; 3: sidewall reinforcement member; 4: foaming body; 41: hollow hole; 5: reinforced carbon fiber layer.

### DESCRIPTION OF EMBODIMENTS

To further illustrate the embodiments, the present invention provides accompanying drawings. The accompanying drawings, as a part of the present disclosure, are mainly used to illustrate the embodiments, and can explain the operating principles of the embodiments with reference to the related descriptions in this specification. With reference to such content, those of ordinary skill in the art can understand other possible implementations and the advantages of the present disclosure. Components in the drawings are not drawn to scale, and similar reference numerals are usually used to represent similar components.

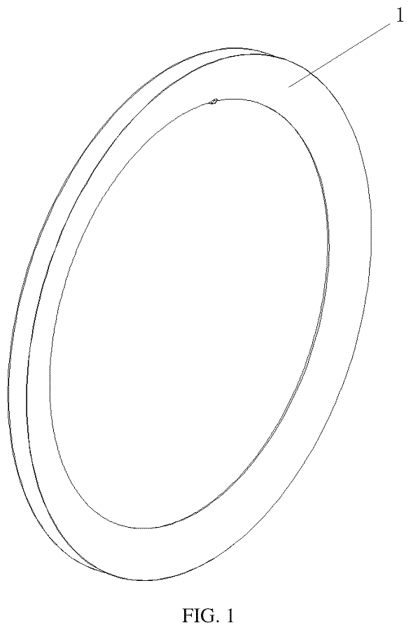

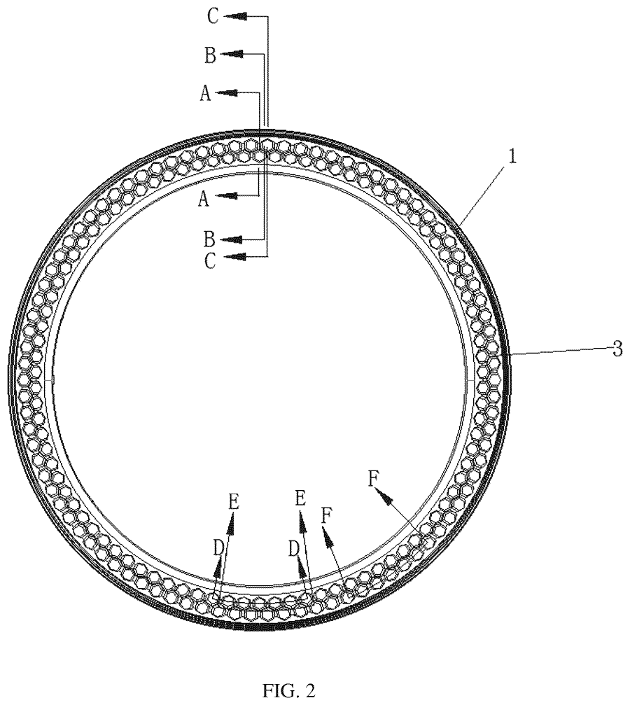

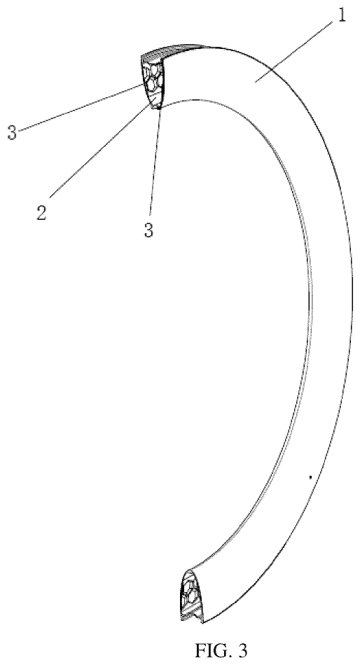

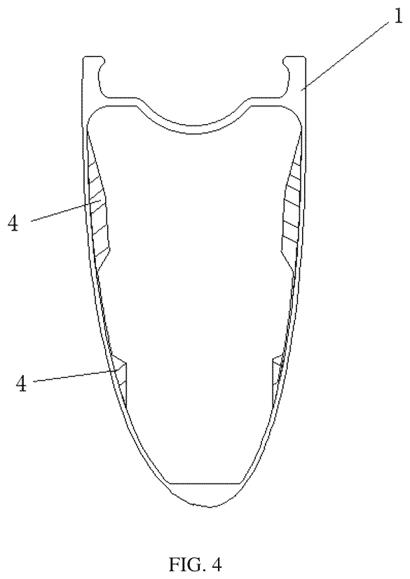

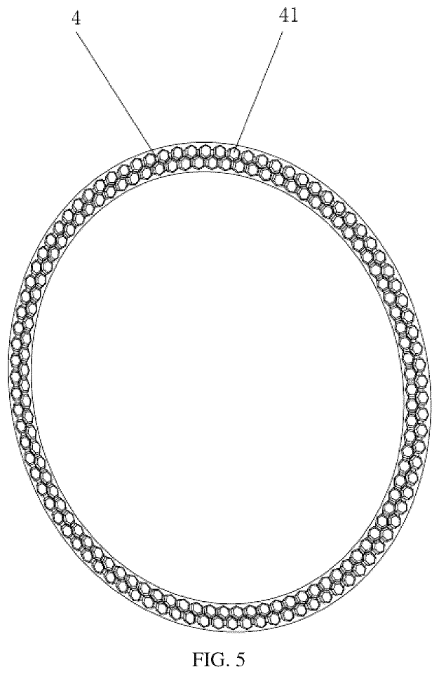

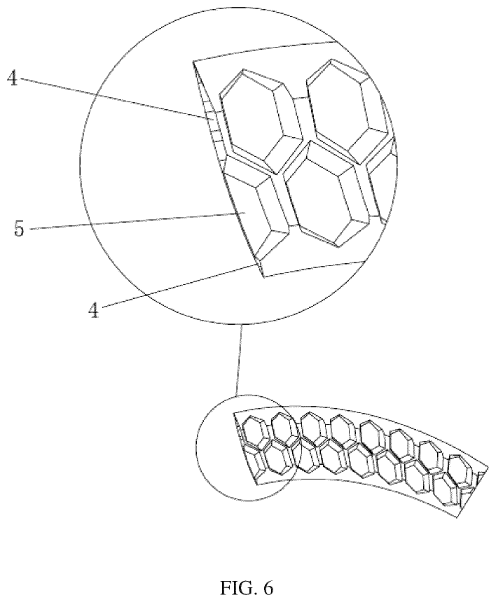

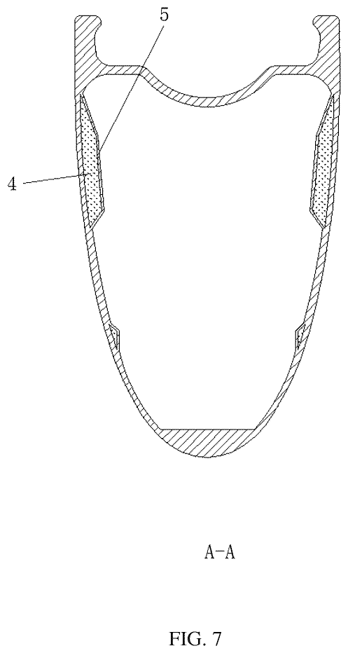

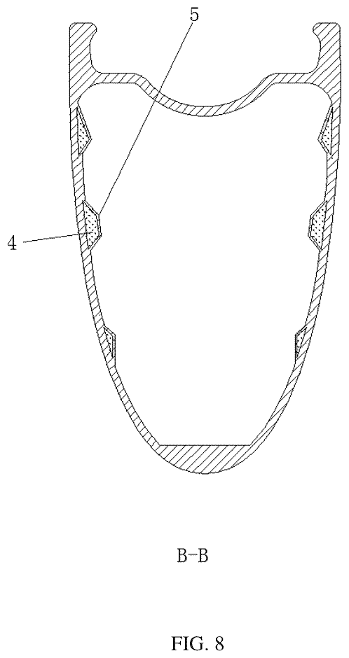

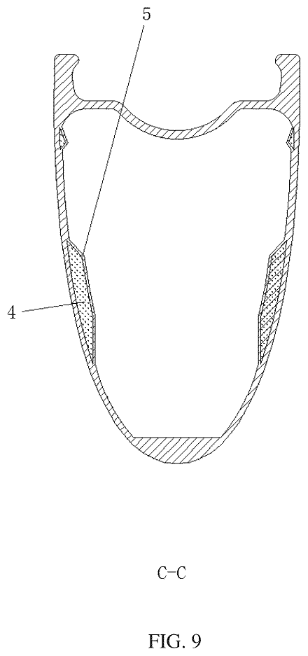

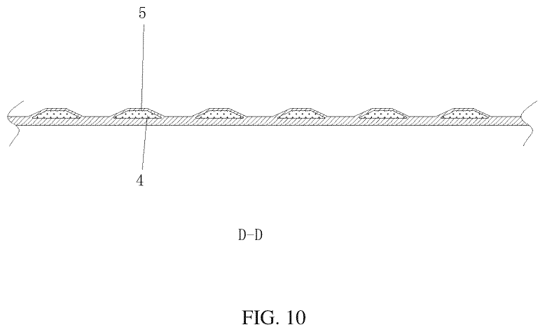

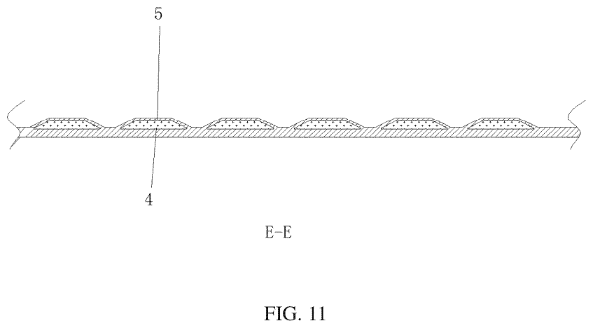

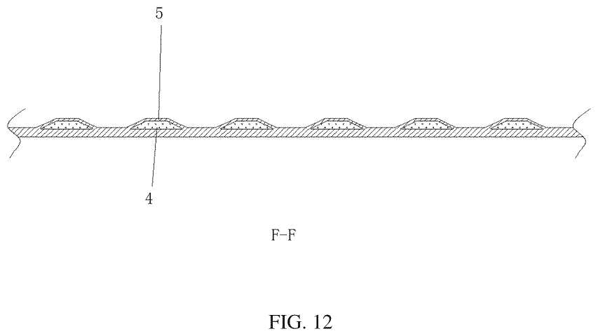

Refer to FIG. 1 to FIG. 12. An embodiment of the present disclosure provides a sidewall-reinforced bicycle rim. The sidewall-reinforced bicycle rim includes a rim body 1 with a cavity 2. The rim body 1 is a carbon fiber rim body. A sidewall reinforcement member 3 is separately embedded in each of inner walls on two sides, corresponding to the cavity 2, of the rim body 1. The sidewall reinforcement member 3 includes a foaming body 4 and reinforced carbon fiber layers 5 that are attached to two sides of the foaming body 4, and the reinforced carbon fiber layer 5 means a reinforced fiber prepreg or a carbon fiber prepreg. The foaming body 4 is of a convex-ribbed mesh structure, a plurality of hollow holes 41 are provided in the foaming body 4, and the reinforced carbon fiber layers 5 on the two sides are closely attached at the hollow holes 41. In this technical solution, because the plurality of hollow holes 41 are not connected to each other, the two reinforced carbon fiber layers 5 are closely attached (or closely bonded) at multiple points between the hollow holes 41. When the rim undergoes thermal expansion or external impacts, continuous delamination does not occur between the reinforced carbon fiber layer 5 and the foaming body 4. This prevents delamination between the foaming body 4 and the rim body 1, so that the reinforcing effect is better and reliability and stability are high. Because of the convex-ribbed mesh structure of the foaming body 4, the foaming body has a small size, lightweight, and larger rigidity. Therefore, the rim is safer and more durable while the lightweight of the rim is ensured.

In this embodiment, the plurality of hollow holes 41 are divided into an inner ring hollow hole group and an outer ring hollow hole group, the inner ring hollow hole group and the outer ring hollow hole group are concentrically disposed, and the hollow holes 41 in the inner ring hollow hole group and the hollow holes 41 in the outer ring hollow hole group are arranged in a staggered manner. This ensures that the strength of the rim is more uniform and stable at other positions.

In this embodiment, the hollow hole 41 is a regular hexagon. Therefore, the sidewall-reinforced bicycle rim is stressed better, stable, and not easily deformed.

In this embodiment, the sidewall reinforcement member 3 is annular, the sidewall reinforcement member 3 includes a plurality of arc-shaped sidewall reinforcement segments, and the plurality of sidewall reinforcement segments are sequentially spliced end to end, to form the annular sidewall reinforcement member 3. Specifically, the sidewall reinforcement member 3 may be formed by splicing six sidewall reinforcement segments. This reduces the costs of developing the molding die. Certainly, the sidewall reinforcement member 3 may be also formed by splicing another quantity of sidewall reinforcement segments, such as 4, 3, or 2 sidewall reinforcement segments. Alternatively, the annular sidewall reinforcement member 3 may be directly formed through processing by using an annular molding die.

In this embodiment, the foaming body 4 is of a continuous convex-ribbed mesh structure. This further improves a reinforcement degree of a sidewall of the rim. Preferably, the foaming body is of a PMI layer, with better stabilization. Certainly, the foaming body may be also of a honeycomb sheet layer.

Density of the foaming body is in a range of 0.05 g/cm³ to 0.3 g/cm³. In this embodiment, foaming density of the foaming body 4 is 0.10 g/cm³.

The present disclosure further provides a method for manufacturing the sidewall-reinforced bicycle rim in the above embodiment. The method includes the following steps.
S1: Manufacture an arc-shaped molding die, where two groups of regular hexagonal groove holes that are arranged in a staggered manner are provided on one side of a molding surface of the molding die.
S2: Attach and press a first reinforced carbon fiber layer 5 within the molding surface first, then attach and press the foaming body 4 on the first reinforced carbon fiber layer 5, and then attach and press a second reinforced carbon fiber layer 5 on the foaming body 4.
S3: Attach the two reinforced carbon fiber layers 5 to each other at a position corresponding to the regular hexagonal groove hole, to form a hexagonal concave surface, and forming a continuous regular hexagonal convex-ribbed mesh structure with the foaming body 4, thereby obtaining the arc-shaped sidewall reinforcement segment.
S4: Perform burring, smoothing, and cleaning on surfaces of the plurality of arc-shaped sidewall reinforcement segments, sequentially splice, end to end, a plurality of arc-shaped sidewall reinforcement segments that are processed and cleaned, to form the annular sidewall reinforcement member 3, attach the sidewall reinforcement member 3 on inner walls on two sides of a pre-formed rim body 1 through a reinforced carbon fiber layer 5, and finally put the sidewall reinforcement member 3 and the rim body 1 into the molding die for molding, to obtain an intact reinforced rim.

Certainly, in step S2, three layers, namely, the reinforced carbon fiber layer 5, the foaming body 4, and the reinforced carbon fiber layer 5 may be attached first, and then directly attached and pressed on the molding surface for molding, to obtain an intact sidewall-reinforced bicycle rim by performing step S3 and step S4.

For the sidewall-reinforced bicycle rim manufactured in the above method, when the rim undergoes thermal expansion or external impacts, continuous delamination does not occur between the reinforced carbon fiber layer 5 and the foaming body 4. This prevents delamination between the foaming body 4 and the rim body 1, so that the reinforcing effect is better and reliability and stability are high. Because of the convex-ribbed mesh structure of the foaming body 4, the foaming body has a small size, lightweight, and larger rigidity. Therefore, the rim is safer and more durable while the lightweight of the rim is ensured.

The following table shows a comparison of rigidity data between a non-reinforced rim in the conventional technology and the sidewall-reinforced rim in this application after assembly.

Comparison of rigidity data between non-reinforced rim
in the conventional technology and the sidewall-
reinforced rim in the present disclosure after assembly.

| | | Test | Test | Rigidity | |
|---|---|---|---|---|---|
| | | strength | result | value | Rigidity |
| Test item | Model | (N) | (mm) | (N/mm) | contrast |
| Lateral | Non-reinforced rim | 20 kg | 6.01 | 3.33 | 100% |
| rigidity | Sidewall-reinforced | | 5.08 | 3.94 | 118% |
| | rim | | | | |
| Forward | Non-reinforced rim | 100 kg | 1.21 | 82.64 | 100% |
| rigidity | Sidewall- | | 1.02 | 98.04 | 119% |
| | reinforced rim | | | | |

Results:
1. The sidewall of the rim of the sidewall-reinforced structure is
relatively hard, and after assembly, lateral rigidity and forward
rigidity are increased by about 20%.

Although the present disclosure is specifically illustrated and described in combination with preferred implementation solutions, those skilled in the art should understand that various changes may be made to the present disclosure in terms of forms and details without departing from the spirit and scope of the present disclosure defined in the appended claims, which shall fall within the protection scope of the present disclosure.

1. A sidewall-reinforced bicycle rim, comprising a rim body with a cavity, wherein a sidewall reinforcement member is separately embedded in inner walls on two sides, corresponding to the cavity, of the rim body, the sidewall reinforcement member comprises a foaming body and reinforced carbon fiber layers that are attached to two sides of the foaming body, the foaming body is of a convex-ribbed mesh structure, a plurality of hollow holes are provided in the foaming body, and the reinforced carbon fiber layers on the two sides of the foaming body are attached at the plurality of hollow holes.

2. The sidewall-reinforced bicycle rim according to claim 1, wherein the plurality of hollow holes are divided into an inner ring hollow hole group and an outer ring hollow hole group, the inner ring hollow hole group and the outer ring hollow hole group are concentrically disposed, and hollow holes in the inner ring hollow hole group and hollow holes in the outer ring hollow hole group are arranged in a staggered manner.

3. The sidewall-reinforced bicycle rim according to claim 1, wherein each of the plurality of hollow holes is a regular hexagon.

4. The sidewall-reinforced bicycle rim according to claim 1, wherein the sidewall reinforcement member is annular.

5. The sidewall-reinforced bicycle rim according to claim 4, wherein the sidewall reinforcement member comprises a plurality of arc-shaped sidewall reinforcement segments, and the plurality of arc-shaped sidewall reinforcement segments are sequentially spliced end to end, to form the sidewall reinforcement member.

6. The sidewall-reinforced bicycle rim according to claim 1, wherein the foaming body is of a continuous convex-ribbed mesh structure.

7. The sidewall-reinforced bicycle rim according to claim 1, wherein the foaming body is a polymethacrylimide (PMI) layer or a honeycomb sheet layer.

8. The sidewall-reinforced bicycle rim according to claim 1, wherein a density of the foaming body is in a range of 0.05 g/cm³ to 0.3 g/cm³.

9. The sidewall-reinforced bicycle rim according to claim 1, wherein the rim body is a carbon fiber rim body.

10. A method for manufacturing the sidewall-reinforced bicycle rim according to claim 1, comprising the following steps:
S1, manufacturing an arc-shaped molding die, wherein two groups of regular hexagonal groove holes that are arranged in a staggered manner are provided on one side of a molding surface of the arc-shaped molding die;
S2, attaching and pressing a first reinforced carbon fiber layer within the molding surface first, then attaching and pressing the foaming body on the first reinforced carbon fiber layer, and then attaching and pressing a second reinforced carbon fiber layer on the foaming body;
S3, attaching the first reinforced carbon fiber layer and the second reinforced carbon fiber layer to each other at a position corresponding to the regular hexagonal groove holes, to form a hexagonal concave surface, and forming a continuous regular hexagonal convex-ribbed mesh structure with the foaming body, thereby obtaining a plurality of arc-shaped sidewall reinforcement segments; and
S4, performing burring, smoothing, and cleaning on surfaces of the plurality of arc-shaped sidewall reinforcement segments, sequentially splicing, end to end, the plurality of arc-shaped sidewall reinforcement segments that are processed and cleaned, to form the sidewall reinforcement member, attaching the sidewall reinforcement member on the inner walls on the two sides of the rim body through a third reinforced carbon fiber layer, and finally putting the sidewall reinforcement member and the rim body into the arc-shaped molding die for molding, to obtain the sidewall-reinforced bicycle rim.
